(19) United States
(12) Patent Application Publication
(10) Pub. No.: US 2012/0192268 A1
(43) Pub. Date: Jul. 26, 2012

(54) PASSWORD AUTHENTICATION METHOD

(75) Inventor: TING-KAI WANG, Tu-Cheng (TW)

(73) Assignee: HON HAI PRECISION INDUSTRY CO., LTD., Tu-Cheng (TW)

(21) Appl. No.: 13/272,269

(22) Filed: Oct. 13, 2011

(30) Foreign Application Priority Data
Jan. 21, 2011 (CN) 201110023796.9

(51) Int. Cl. G06F 21/00; G06F 7/04

(52) U.S. Cl. 726/19

(57) ABSTRACT

A password authentication method applied to an input recognition device with a touch sensitive screen, the password authentication method comprises defining and displaying at least one image according to the movement of an object touching on a touch sensitive screen, detecting a final position of the at least one image, and judging whether the at least one image and the final position thereof match a predetermined password or not; and if so entering an unlocking mode.

### BACKGROUND

1. Technical Field

The present disclosure relates to password authentication methods, and in particular, to a password authentication method applicable to an input recognition device with a touch sensitive screen.

2. Description of Related Art

Typical passwords usually consist of alphanumeric characters, and users input the passwords by pressing a number of keys displayed in a touch sensitive screen. However, each alphanumeric character is always displayed in a particular position of the touch sensitive screen, and when inputting passwords, shoulder surfing may result in the password being compromised.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flowchart of a password authentication method in accordance with an embodiment.

FIG. 2 is a schematic view showing the operation of the password authentication method of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

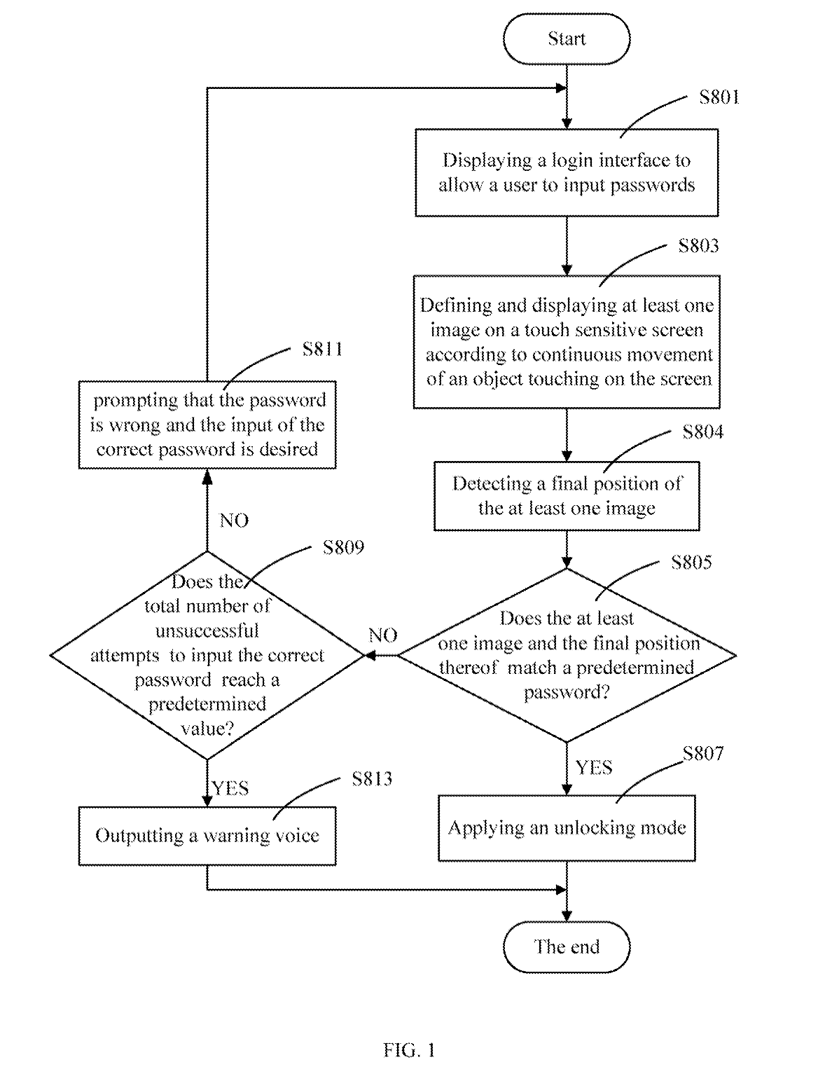

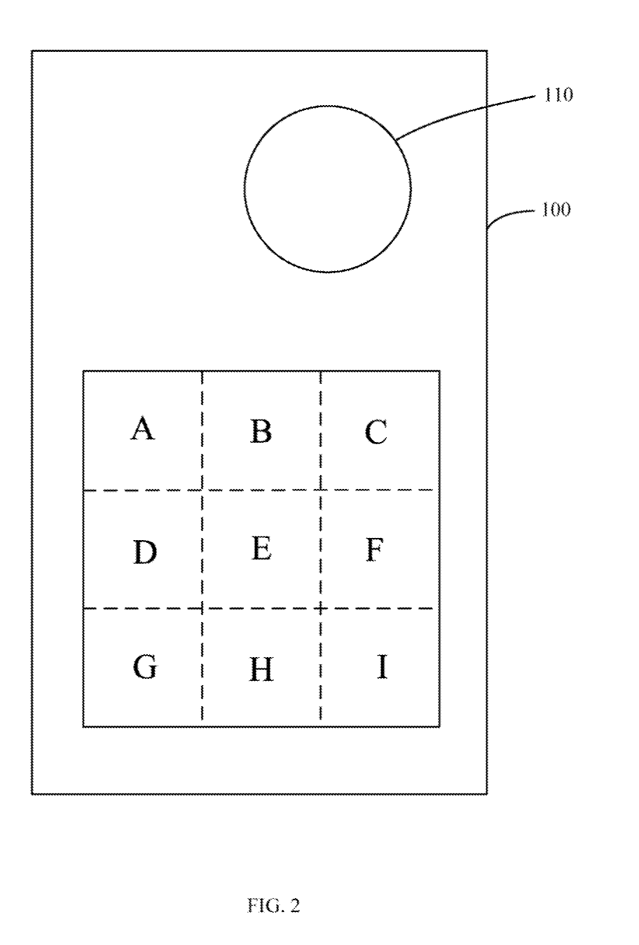

Referring to FIGS. 1 and 2, a password authentication method is applied in an input recognition device with a touch sensitive screen 100. In some embodiments, the input recognition device may be a mobile phone, a tablet computer or other electronic device with a touch sensitive screen. The password authentication method includes the following the steps:

In step S801, displaying a login interface to allow the user to input the password. In other embodiments, the login interface may also allow the user to input both usernames and passwords.

In step S803, identifying continuous movement of an object such as a human finger touching on the screen 100, defining and displaying at least one image 110 on the screen 100 according to the movement. For example, a circle may be defined and displayed when circular continuous movements are identified on the screen 100. In the illustrated embodiment, the at least one image 110 may have any shape such as a circle or a wavy line. A first particular operation may be designated as the end of the at least one image 110. In some embodiments, the first particular operation is a signal tap on the touch sensitive screen 100.

In step S804, detecting the final position of the at least one image 110. The final position of the at least one image 110 may be where the image 110 is displayed or the position where the image 110 is finally dragged. In some embodiments, the screen 100 may define a plurality independent regions such as the regions A, B, C, D, E, F, G, H and I shown in FIG. 2 to allow the at least one image 110 to be dragged thereto, and the final position of the at least one image 110 is the position of at least one of the independent regions to which the at least one image 110 is dragged to. These independent regions may be not visible or may be visible in the form of a shape in a particular position of the screen 100. In some embodiments, the position and shape and size of each independent region may be manually set by users or by the manufacturers of the input recognition device. A second particular operation designated as the end of the operation of the dragging the image 110. In some embodiments, the second particular operation may a double tap on the screen 100.

In step S805, judging whether or not the at least one image 110 and the final position thereof match a predetermined password. If the at least one image 110 and the final position thereof match the predetermined password, the procedure goes to step S807. If the at least one image 110 and the final position of the at least one image 110 do not match the predetermined password, the procedure goes to step S809. The predetermined password includes a predetermined image and a predetermined final position of the predetermined image. In the illustrated embodiment, if the shape of the at least one image 110 is within a predetermined changing tolerance of the predetermined image, and if the at least one image 110 is finally located in the predetermined final position, the at least one image 110 and the final position thereof are judged to match the predetermined password.

In step S807, applying an unlocking mode to allow the user to operate the input recognition device.

In step S809, judging whether the total number of unsuccessful attempts to input the correct password has reached a predetermined value, such as, 3 attempts. If the number of failures in inputting the correct password has not reached the predetermined value, the procedure goes to step S801, and if the number of failures has reached the predetermined value, the procedure goes to step S813.

In step S811, prompting that the password is wrong and the input of the correct password is desired and the procedure returns to step S801. In the illustrated embodiment, the input recognition input device may output an audio signal to warn users that the entered password is wrong.

In step S813, the input recognition device outputs a warning voice that the person who is attempting to input the password may be an unauthorized person. In this situation, further attempts including correct password attempts may fail for a predetermined period of time.

With the above password authentication method, the password of the input recognition device is combined in at least one image 110 and the final position thereof, but is not an alphanumeric display in a particular position of the screen 110. Therefore, nearby persons can not easily obtain the passwords merely by watching the touches on the screen.

When some of the independent regions are visible and others are not visible, an illusion that the user is playing games may be produced when a user is inputting the password, which may protect the password security. Additionally, when all the regions are not visible, nearby persons cannot know the arrangement of the independent regions, therefore, nearby persons would find it very difficult to obtain the password even if they are able to view the process of the input of the password.

It is to be understood, however, that even though information and the advantages of the present embodiments have been set forth in the foregoing description, together with details of the structures and functions of the present embodiments, the disclosure is illustrative only; and that changes may be made in detail, especially in the matters of shape, size, and arrangement of parts within the principles of the present embodiments to the full extent indicated by the broad general meaning of the terms in which the appended claims are expressed.

What is claimed is:

1. A password authentication method applied to an input recognition device with a touch sensitive screen, comprising the following steps:
displaying a login interface for allowing a user to input a password;
defining and displaying at least one image on the touch sensitive screen according to continuous movement of an object touching the touch sensitive screen;
detecting a final position of the at least one image;
judging whether the at least one image and the final position of the at least one image match a predetermined password or not; and
applying an unlocking mode to allow the user to operate the input recognition device if the at least one image and the position thereof match the predetermined password.

2. The password authentication method of claim 1, wherein the predetermined password comprises a predetermined image and a predetermined final position of the predetermined image.

3. The password authentication method of claim 1, further comprising the following step:
prompting that the password is wrong and the input of the correct password is desired if the at least one image and the final position thereof do not match the predetermined password.

4. The password authentication method of claim 3, wherein a warning sound is outputted if the at least one image and the final position thereof do not match the predetermined password.

5. The password authentication method of claim 1, further comprising the following method:
judging whether the total number of unsuccessful attempts to input the correct password reaches a predetermined value or not;
outputting a warning voice if the total number of failures in inputting the correct password reaches the predetermined value.

6. The password authentication method of claim 5, further comprising the following step:
returning to the step of displaying the login interface for allowing the user to re-input the password if the total number of failures in inputting the correct password does not reach the predetermined value.

7. The password authentication method of claim 2, wherein if the shape of the at least one image is within a predetermined changing tolerance, the at least one image is judged to match the predetermined image.

8. The password authentication method of claim 1, wherein the final position of the at least one image is the position to which the at least one image is dragged.

9. The password authentication method of claim 8, wherein the touch sensitive screen defining a plurality of independent regions to allow the at least one image to be dragged thereto, and the final position of the at least one image is the position of at least one of the independent regions to which the at least one image is dragged to.

10. The password authentication method of claim 9, wherein a first particular operation is designated for as the end of the at least one image.

11. The password authentication method of claim 10, wherein the first particular operation is a single tap on the touch sensitive screen.

12. The password authentication method of claim 10, wherein a second particular operation is designated as the end of the operation of dragging of the at least one image.

13. The password authentication method of claim 12, wherein the second particular operation is a double tap on the touch sensitive screen.

14. The password authentication method of claim 9, wherein the independent regions are not visible.

15. The password authentication method of claim 9, wherein the independent regions are visible.

16. The password authentication method of claim 9, wherein a part of the independent regions are visible and the other part of the independent regions are not visible.

17. The password authentication method of claim 1, wherein the at least one image is a circle.
